(19) United States
(12) Patent Application Publication
(10) Pub. No.: US 2023/0021510 A1
(43) Pub. Date: Jan. 26, 2023

(54) APPARATUS AND METHOD OF WIRELESS COMMUNICATION

(71) Applicant: GUANGDONG OPPO MOBILE TELECOMMUNICATIONS CORP.,LTD., Dongguan (CN)

(72) Inventor: Li GUO, Allen, TX (US)

(73) Assignee: GUANGDONG OPPO MOBILE TELECOMMUNICATIONS CORP.,LTD., Dongguan (CN)

(21) Appl. No.: 17/948,978

(22) Filed: Sep. 20, 2022

Related U.S. Application Data
(63) Continuation of application No. PCT/CN2021/082912, filed on Mar. 25, 2021.
(60) Provisional application No. 63/009,189, filed on Apr. 13, 2020.

(51) Int. Cl. H04W 24/10; H04B 17/318; H04B 17/336; H04W 16/28

(52) U.S. Cl. CPC H04W 24/10; H04B 17/318; H04B 17/336; H04W 16/28

(57) ABSTRACT

An apparatus and a method of wireless communication are provided. A user equipment (UE) includes a memory; a transceiver; and a processor coupled to the memory and the transceiver; wherein the processor is configured, by a first base station configured to control a serving cell to the UE, to measure transmission beams transmitted by a second base station configured to control a non-serving cell to the UE. This can solve issues in the prior art, provide a beam management of a non-serving cell, improve a latency in a multi-beam operation, provide a good communication performance, and/or provide high reliability.

### CROSS REFERENCE TO RELATED APPLICATIONS

This This application is a continuation of International Application No. PCT/CN2021/082912, filed on Mar. 25, 2021, which claims priority to U.S. Provisional Application No. 63/009,189, filed Apr. 13, 2020. The entire disclosure of this application is incorporated herein by reference.

### BACKGROUND OF DISCLOSURE

### 1. Field of the Disclosure

The present disclosure relates to the field of communication systems, and more particularly, to an apparatus and a method of wireless communication, which can provide a good communication performance and/or high reliability.

### 2. Description of the Related Art

New radio (NR)/fifth-generation (5G) systems support beam management functions to support multi-beam operations in frequency range 2 (FR2) systems. The beam management functions include the functions of beam measurement and reporting and beam indication. Drawbacks of the beam management include that the UE can only measure a reference signal of a serving cell for beam measurement and reporting and only a channel state information reference signal (CSI-RS), a synchronization signal (SS)/physical broadcast channel (PBCH) or a sounding reference signal (SRS) can be used to indicate a Tx beam for physical downlink control channel (PDCCH), physical downlink shared channel (PDSCH), or an uplink transmission. When the UE moves from one cell to another cell, the UE would have to go through an initial access and random access channel (RACH) again to align a beam link with a neighbor cell. That would cause a long latency in a multi-beam operation, and a service between a system and the UE might be interrupted due to non-aligned beam pair link.

Therefore, there is a need for an apparatus (such as a user equipment (UE) and/or a base station) and a method of wireless communication, which can solve issues in the prior art, provide a beam management of a non-serving cell, improve a latency in a multi-beam operation, provide a good communication performance, and/or provide high reliability.

### SUMMARY

An object of the present disclosure is to propose an apparatus (such as a user equipment (UE) and/or a base station) and a method of wireless communication, which can solve issues in the prior art, provide a beam management of a non-serving cell, improve a latency in a multi-beam operation, provide a good communication performance, and/or provide high reliability.

In a first aspect of the present disclosure, a method of wireless communication by a first base station comprises configuring, by the first base station configured to control a serving cell to a user equipment (UE), the UE to measure transmission beams transmitted by a second base station configured to control a non-serving cell to the UE.

In a second aspect of the present disclosure, a user equipment comprises a memory, a transceiver, and a processor coupled to the memory and the transceiver. The processor is configured, by a first base station configured to control a serving cell to the UE, to measure transmission beams transmitted by a second base station configured to control a non-serving cell to the UE.

In a third aspect of the present disclosure, a base station comprises a memory, a transceiver, and a processor coupled to the memory and the transceiver and configured to control a serving cell to a user equipment (UE). The processor is configured to configure the UE to measure transmission beams transmitted by a second base station configured to control a non-serving cell to the UE.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs), a first base station, and a second base station of communication in a communication network system according to an embodiment of the present disclosure.

FIG. 2 is a flowchart illustrating a method of wireless communication by a user equipment (UE) according to an embodiment of the present disclosure.

FIG. 3 is a flowchart illustrating a method of wireless communication by a first base station according to an embodiment of the present disclosure.

FIG. 4 is a schematic diagram illustrating an example of a beam management on beams of a non-serving cell according to an embodiment of the present disclosure.

FIG. 5 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

New radio (NR)/fifth-generation (5G) system supports a beam management to support a multi-beam operation in a frequency range 2 (FR2) system. The beam management includes a beam measurement and reporting and a beam indication. In the beam measurement and reporting, a base station (e.g. gNB) can configure a user equipment (UE) to measure a set of multiple transmission (Tx) beams and then the UE can report measurement results of a few Tx beams. In the beam indication, the gNB can indicate information of which Tx beam is used to transmit one downlink channel or reference signal, and the gNB can also indicate information of which UE Tx beam may be used to transmit one uplink channel or reference signal.

In the NR/5G system, L1-RSRP-based beam measurement and reporting and L1-SINR based beam measurement and reporting are provided. For L1-RSRP-based beam reporting, the UE can be configured with up to 64 CSI-RS resources or SS/PBCH blocks for L1-RSRP measurement. The UE can select up to 4 CSI-RS resources or SS/PBCH blocks from those configured resources and then report the indicators of those selected CSI-RS resources or SS/PBCH blocks and corresponding L1-RSRP measurement results to the gNB. The 3GPP release 15 specification also supports group-based L1-RSRP beam report, in which a UE can be configured with a resource setting for channel measurement that contains a set of NZP CSI-RS resources or SS/PBCH blocks. Each NZP CSI-RS resource or SS/PBCH block is used to represent one gNB transmit beam. The UE is configured to measure the L1-RSRP of those NZP CSI-RS resources or SS/PBCH blocks. Then the UE can report two CRIs or SSBRIs for two selected NZP CSI-RS resources or SS/PBCH blocks which the UE is able to use a single spatial domain receive filter or multiple simultaneous spatial domain receive filters.

L1-SINR based beam measurement and reporting is specified in release 16. For L1-SINR based beam measurement and reporting, the UE can be configured with one of the following resource setting configurations: The UE is configured with one resource setting with a set of NZP CSI-RS resources for channel measurement and interference measurement. The UE is configured with two resource settings. The first resource setting has a set of NZP CSI-RS resources or SS/PBCH blocks for channel measurements and the second resource setting has a set of NZP CSI-RS resource or ZP CSI-RS resource for interference measurement.

For L1-SINR beam report, the UE can report up to 4 CRIs or SSBRIs and the corresponding L1-SINR measurement results. Group-based beam report of L1-SINR is also supported, in which the UE can report up to 2 CRIs or SSBRIs and the corresponding L1-SINR measurement results.

For the beam indication for downlink channel and reference signal, such as PDCCH, PDSCH, or CSI-RS, a TCI state framework is adopted in the NR/5G system. The UE is first configured with a list of M TCI-states. Each TCI-State contains parameters for configuring a quasi co-location relationship between one or two downlink reference signals and DM-RS ports of the PDSCH, DM-RS port of the PDCCH or CSI-RS port(s) of a CSI-RS resource. The quasi co-location relationship is configured by a higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: ‘QCL-Type A’: {Doppler shift, Doppler spread, average delay, delay spread}, ‘QCL-Type B’: {Doppler shift, Doppler spread}, ‘QCL-Type C’: {Doppler shift, average delay}, or ‘QCL-Type D’: {Spatial Rx parameter}. Here, the QCL-Type D parameter is used to indicate the Tx beam information.

For the beam indication for uplink channel and signal, such as PUCCH, PUSCH, or SRS, a method of spatial relation is utilized in the NR/5G system. For each SRS resource, the UE is provided with a configuration of spatial relation, which the spatial relation between a reference RS and a target SRS, where a higher layer parameter spatialRelationInfo, if configured, contains ID of the reference RS. The reference RS may be an SS/PBCH block, CSI-RS configured on a serving cell indicated by higher layer parameter servingCellId if present, same serving cell as the target SRS otherwise, or an SRS configured on uplink BWP indicated by the higher layer parameter uplinkBWP, and serving cell indicated by the higher layer parameter servingCellId if present, same serving cell as the target SRS otherwise. For the transmission of PUCCH, a spatial relation configuration can be provided to a PUCCH resource. A spatial setting for a PUCCH transmission is provided by PUCCH-SpatialRelationInfo if the UE is configured with a single value for pucch-SpatialRelationInfold; otherwise, if the UE is provided multiple values for PUCCH-SpatialRelationInfo, the UE determines a spatial setting for the PUCCH transmission. The UE applies corresponding actions and a corresponding setting for a spatial domain filter to transmit PUCCH in the first slot that is after slot k+3·Nₛₗₒₜ^{subframe,μ} where k is the slot where the UE would transmit a PUCCH with HARQ-ACK information with ACK value corresponding to a PDSCH reception providing the PUCCH-SpatialRelationInfo and μ is the SCS configuration for the PUCCH.

If PUCCH-SpatialRelationInfo provides ssb-Index, the UE transmits the PUCCH using a same spatial domain filter as for a reception of a SS/PBCH block with index provided by ssb-Index for a same serving cell or, if servingCellId is provided, for a serving cell indicated by servingCellId. Else if PUCCH-SpatialRelationInfo provides csi-RS-Index, the UE transmits the PUCCH using a same spatial domain filter as for a reception of a CSI-RS with resource index provided by csi-RS-Index for a same serving cell or, if servingCellId is provided, for a serving cell indicated by servingCellId. Else PUCCH-SpatialRelationInfo provides srs, the UE transmits the PUCCH using a same spatial domain filter as for a transmission of a SRS with resource index provided by resource for a same serving cell and/or active UL BWP or, if servingCellId and/or uplinkBWP are provided, for a serving cell indicated by servingCellId and/or for an UL BWP indicated by uplinkBWP.

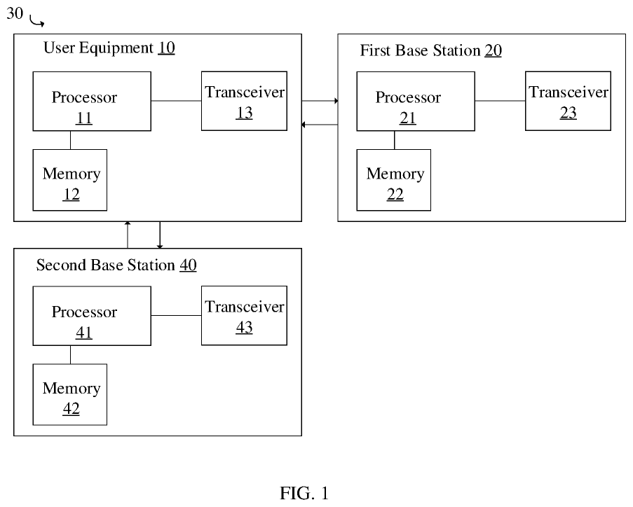

FIG. 1 illustrates that, in some embodiments, one or more user equipments (UEs) 10, a first base station (e.g., gNB or eNB) 20, and a second base station (e.g., gNB or eNB) 40 for transmission adjustment in a communication network system 30 according to an embodiment of the present disclosure are provided. The communication network system 30 includes the one or more UEs 10, the first base station 20, and the second base station 40. The one or more UEs 10 may include a memory 12, a transceiver 13, and a processor 11 coupled to the memory 12 and the transceiver 13. The first base station 20 may include a memory 22, a transceiver 23, and a processor 21 coupled to the memory 22 and the transceiver 23. The second base station 40 may include a memory 42, a transceiver 43, and a processor 41 coupled to the memory 42 and the transceiver 43. The processor 11 or 21 or 41 may be configured to implement proposed functions, procedures and/or methods described in this description. Layers of radio interface protocol may be implemented in the processor 11 or 21 or 41. The memory 12 or 22 or 42 is operatively coupled with the processor 11 or 21 or 42 and stores a variety of information to operate the processor 11 or 21 or 41. The transceiver 13 or 23 or 43 is operatively coupled with the processor 11 or 21 or 41, and the transceiver 13 or 23 or 43 transmits and/or receives a radio signal.

The processor 11 or 21 or 41 may include application-specific integrated circuit (ASIC), other chipset, logic circuit and/or data processing device. The memory 12 or 22 or 42 may include read-only memory (ROM), random access memory (RAM), flash memory, memory card, storage medium and/or other storage device. The transceiver 13 or 23 or 43 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 or 42 and executed by the processor 11 or 21 or 41. The memory 12 or 22 or 42 can be implemented within the processor 11 or 21 or 41 or external to the processor 11 or 21 or 41 in which case those can be communicatively coupled to the processor 11 or 21 or 41 via various means as is known in the art.

In some embodiments, the processor 11 is configured, by the first base station 20 configured to control a serving cell to the UE 10, to measure transmission beams transmitted by the second base station 40 configured to control a non-serving cell to the UE 10. This can solve issues in the prior art, provide a beam management of a non-serving cell, improve a latency in a multi-beam operation, provide a good communication performance, and/or provide high reliability.

In some embodiments, the processor 21 is configured to control the serving cell to the UE 10, and the processor 21 is configured to configure the UE 10 to measure transmission beams transmitted by the second base station 40 configured to control the non-serving cell to the UE 10. This can solve issues in the prior art, provide a beam management of a non-serving cell, improve a latency in a multi-beam operation, provide a good communication performance, and/or provide high reliability.

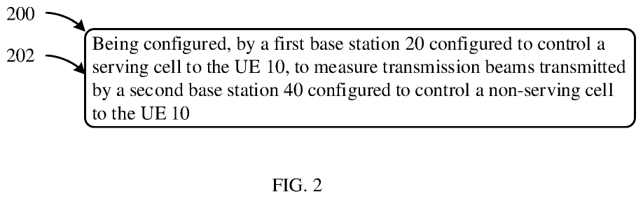

FIG. 2 illustrates a method 200 of wireless communication by a UE 10 according to an embodiment of the present disclosure. In some embodiments, the method 200 includes: a block 202, being configured, by a first base station 20 configured to control a serving cell to the UE 10, to measure transmission beams transmitted by a second base station 40 configured to control a non-serving cell to the UE 10. This can solve issues in the prior art, provide a beam management of a non-serving cell, improve a latency in a multi-beam operation, provide a good communication performance, and/or provide high reliability.

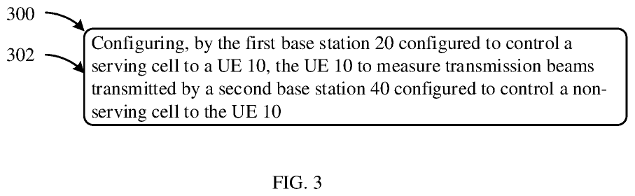

FIG. 3 illustrates a method 300 of wireless communication by a first base station 20 according to an embodiment of the present disclosure. In some embodiments, the method 300 includes: a block 302, configuring, by the first base station 20 configured to control a serving cell to a UE 10, the UE 10 to measure transmission beams transmitted by a second base station 40 configured to control a non-serving cell to the UE 10. This can solve issues in the prior art, provide a beam management of a non-serving cell, improve a latency in a multi-beam operation, provide a good communication performance, and/or provide high reliability.

In some embodiments, the transmission beams are transmitted through channel state information reference signal (CSI-RS) resources or synchronization signal (SS)/physical broadcast channel (PBCH) blocks transmitted by the second base station 40. In some embodiments, the method further comprises the UE 10 being requested, by the first base station 20, to report a measurement of the transmission beams transmitted by the second base station 40. In some embodiments, the measurement of the transmission beams transmitted by the second base station 40 comprises a reference signal received power (RSRP) measurement, a reference symbol received quality (RSRQ) measurement, or a signal to interference noise ratio (SINR) measurement of the transmission beams transmitted by the second base station 40. In some embodiments, the RSRP measurement, the RSRQ measurement, or the SINR measurement of the transmission beams transmitted by the second base station 40 comprises a layer 1 RSRP (L1-RSRP) measurement, a layer 1 RSRQ (L1-RSRQ) measurement, or a layer 1 SINR (L1-SINR) measurement of the transmission beams transmitted by the second base station 40.

In some embodiments, the method further comprises the UE 10 being configured, by the first base station 20, to receive a downlink channel or signal with a beam of the transmission beams transmitted by the second base station 40. In some embodiments, the downlink channel or signal comprises a physical downlink shared channel (PDSCH), a physical downlink control channel (PDCCH), or a CSI-RS resource. In some embodiments, the beam of the transmission beams transmitted by the second base station 40 is configured by the first base station 20 for a quasi co-location (QCL) type in a transmission configuration indicator (TCI) state. In some embodiments, the method further comprises the UE 10 being configured, by the first base station 20, to transmit an uplink channel or signal with an uplink transmission beam, and the uplink transmission beam is aligned with a beam of the transmission beams transmitted by the second base station 40.

In some embodiments, the uplink channel or signal comprises a physical uplink shared channel (PUSCH) or a physical uplink control channel (PUCCH). In some embodiments, the beam of the transmission beams transmitted by the second base station 40 is configured by the first base station 20 in a spatial relation information for a PUCCH resource. In some embodiments, the beam of the transmission beams transmitted by the second base station 40 is configured by the first base station 20 as a pathloss reference signal for a PUCCH transmission or a PUSCH transmission. In some embodiments, the method further comprises the UE 10 being configured, by the first base station 20, to report CSI of the transmission beams transmitted by the second base station 40. In some embodiments, the CSI of the transmission beams transmitted by the second base station 40 comprises a channel quality indicator (CQI), a precoding matrix indicator (PMI), a CSI-RS resource indicator (CRI), a SS/PBCH block resource indicator (SSBRI), a layer indicator (LI), a rank indicator (RI), a L1-RSRP, or a L1-SINR of the transmission beams transmitted by the second base station 40. In some embodiments, for the CQI, the PMI, the CRI, the SSBRI, the LI, the RI, the L1-RSRP, or the L1-SINR of the transmission beams transmitted by the second base station 40, the UE 10 is configured by higher layers with reporting settings, resource settings, or one or more lists of trigger states.

Some embodiments support the function of beam management on the non-serving cell. The serving gNB 20 can configure the UE 10 to measure Tx beams of the non-serving cell and also report beam measurement results to the gNB 20. The gNB 20 can also configure a Tx beam of the non-serving cell as a Tx beam for PDSCH or PDCCH transmission, and the gNB can configure a Tx beam for PUCCH or SRS transmission with a beam direction that points to the non-serving cell.

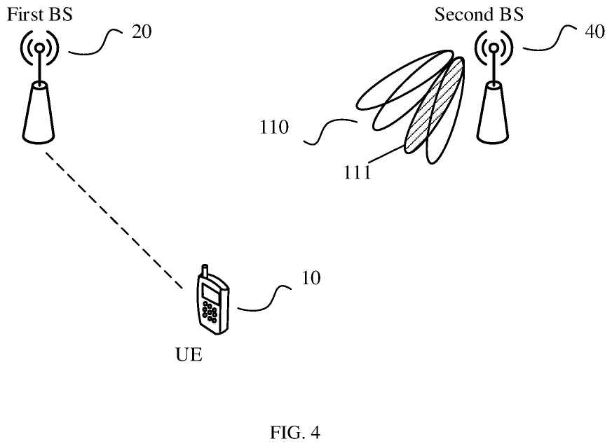

FIG. 4 illustrates an example of a beam management on beams of a non-serving cell according to an embodiment of the present disclosure. As illustrated in FIG. 4, a first base station 20 is the serving cell for a UE 10. The second base station 40 is not a serving cell to the UE 10. The UE 10 can be requested, for example, by the first base station 20, to measure a set of Tx beams 110 that are transmitted by the second base station 40. The Tx beams 110 can be transmitted through some CSI-RS resources or SS/PBCH blocks transmitted by the second base station 40. The UE 10 can be requested to report measurement results, which can include measurement metric for example L1-RSRP or L1-RSRQ or L1-SINR. The first base station 20 can indicate the UE 10 that PDCCH or PDSCH or CSI-RS is transmitted by a system with a Tx beam 111 from the second base station 40. With such configuration information, the UE 10 can use proper receive configuration to receive the PDCCH, PDSCH, or CSI-RS. The first base station 20 can also indicate the UE 10 to transmit uplink channel PUSCH or PUCCH with a UE Tx beam that is aligned with some beam of the second base station 40.

In some embodiments, a UE 10 can be configured by his serving base station (BS) 20 to measure a set of Tx beams of another BS 40 that is a non-serving cell and the UE 10 can be requested to report a measurement result, for example, a RSRP or RSRQ or SINR measurement of the Tx beams on another BS 40. The UE 10 can be configured to receive downlink channel or signal, for example PDSCH, PDCCH, or CSI-RS resource by assuming that the downlink channel or signal for example PDSCH, PDCCH or CSI-RS are transmitted with a Tx beam from another BS 40 that is a non-serving cell. The UE 10 can also be configured by the serving BS 20 to transmit an uplink channel or signal with an uplink transmit beam that is aligned with a beam of another BS 40 that is a non-serving cell.

Beam measurement and reporting for non-serving cell:

In an exemplary method, time and frequency resources that can be used by a UE 10 to report CSI are controlled by a gNB 20. CSI may include channel quality indicator (CQI), preceding matrix indicator (PMI), CSI-RS resource indicator (CRI), SS/PBCH block resource indicator (SSBRI), layer indicator (LI), rank indicator (RI), L1-RSRP, or L1-SINR. For CQI, PMI, CRI, SSBRI, LI, RI, L1-RSRP, or L1-SINR, the UE 10 is configured by higher layers with N>1 CSI-ReportConfig reporting settings, M>1 CSI-ResourceConfig resource settings, and one or two lists of trigger states (given by higher layer parameters, CSI-AperiodicTriggerStateList and CSI-SemiPersistentOnPUSCH-TriggerStateList. Each trigger state in CSI-AperiodicTriggerStateList includes a list of associated CSI-ReportConfigs indicating resource set IDs for channel and optionally for interference. Each trigger state in CSI-SemiPersistentOnPUSCH-TriggerStateList includes one associated CSI-ReportConfig.

Each CSI resource setting CSI-ResourceConfig includes a configuration of a list of S>1 CSI resource sets (given by a higher layer parameter csi-RS-ResourceSetList), where the list includes references to either or both of NZP CSI-RS resource set(s) and SS/PBCH block set(s) or SS/PBCH block set(s) of a non-serving cell or the list includes references to CSI-IM resource set(s). Each CSI resource setting is located in a DL BWP identified by a higher layer parameter BWP-id, and all CSI resource settings linked to a CSI report setting have the same DL BWP.

For L1-SINR measurement, the UE 10 can be provided with the following configurations. When a resource setting is configured, the resource setting (given by a higher layer parameter resourcesForChannelMeasurement) is for channel and interference measurement for L1-SINR computation. The UE 10 may assume that same 1 port NZP CSI-RS resource(s) with density 3 REs/RB is used for both channel and interference measurements. When two resource settings are configured, a first resource setting (given by the higher layer parameter resourcesForChannelMeasurement) is for channel measurement on SSB or NZP CSI-RS or SSB (or SS/PBCH Block resources) of the non-serving cell and a second resource setting (given by either higher layer parameter csi-IM-ResourcesForinterference or higher layer parameter nzp-CSI-RS-ResourcesForinterference) is for interference measurement performed on CSI-IM or on 1 port NZP CSI-RS with density 3 REs/RB, where each SSB or NZP CSI-RS resource or SSB of the non-serving cell for channel measurement is associated with one CSI-IM resource or one NZP CSI-RS resource for interference measurement by the ordering of the SSB or NZP CSI-RS resource or SSB of the non-serving cell for channel measurement and CSI-IM resource or NZP CSI-RS resource for interference measurement in the corresponding resource sets. The number of SSB(s) or CSI-RS resources for channel measurement equals to the number of CSI-IM resources or the number of NZP CSI-RS resource for interference measurement.

The UE 10 may apply ‘QCL-Type D’ assumption of the SSB or SSB of the non-serving cell or ‘QCL-Type D’ configured to the NZP CSI-RS resource for channel measurement to measure the associated CSI-IM resource or associated NZP CSI-RS resource for interference measurement configured for one CSI reporting. The UE 10 may expect that the NZP CSI-RS resource set for channel measurement and the NZP-CSI-RS resource set for interference measurement, if any, are configured with a higher layer parameter repetition.

For L1-RSRP computation, the UE 10 may be configured with CSI-RS resources, SS/PBCH block resources or both CSI-RS and SS/PBCH block resources, when resource-wise quasi co-located with ‘QCL-Type C’ and ‘QCL-Type D’ when applicable, or SS/PBCH block resources of the non-serving cell.

For L1-SINR computation, in the channel measurement, the UE 10 may be configured with NZP CSI-RS resources and/or SS/PBCH Block resources or SS/PBCH Block resources of the non-serving cell. For interference measurement, the UE 10 may be configured with NZP CSI-RS or CSI-IM resources. For channel measurement, the UE 10 may be configured with CSI-RS resource setting up to 64 CSI-RS resources or up to 64 SS/PBCH block resources or up to 64 SS/PBCH Block resources of the non-serving cell.

For L1-SINR reporting, if a higher layer parameter nrofReportedRSForSINR in CSI-ReportConfig is configured to be one, the reported L1-SINR value is defined by a 7-bit value in the range [−23, 40] dB with 0.5 dB step size, and if the higher layer parameter nrofReportedRSForSINR is configured to be larger than one, the UE 10 can use differential L1-SINR based reporting, where the largest measured value of L1-SINR is quantized to a 7-bit value in the range [−23, 40] dB with 0.5 dB step size, and the differential L1-SINR is quantized to a 4-bit value. The differential L1-SINR is computed with 1 dB step size with a reference to the largest measured L1-SINR value which is part of the same L1-SINR reporting instance. When NZP CSI-RS is configured for channel measurement and/or interference measurement, the reported L1-SINR values cannot be compensated by the power offset(s) given by higher layer parameter powerControOffsetSS or powerControlOffset.

In an exemplary method, if the UE 10 is configured with a CSI-ReportConfig with the higher layer parameter reportQuantity set to ‘ssb-Index-RSRP’, the UE 10 can report SSBRI, where SSBRI k (k≥0) corresponds to the configured (k+1)-th entry of the associated csi-SSB-ResourceList in the corresponding CSI-SSB-ResourceSet or CSI-SSBNcell-ResourceSet.

In an exemplary method, to configure an SS/PBCH block of a non-serving cell as a resource for CSI measurement and reporting, the UE 10 can be provided with the following parameters: 1. Physical cell ID (PCI) of a cell to identify one cell, ssbFrequency with values: ARFCN-ValueNR to indicate the carrier frequency of the SS/PBCH transmission, halfFrameIndex with values: 0 or 1, SSB-periodicity to indicate the transmission periodicity of the SS/PBCH blocks, 2. ssbSubcarrierSpacing to indicate the subcarrier spacing used by the SS/PBCH block transmission, 3. SFN-SSBoffset to indicate the slot offset of the SS/PBCH block transmission, 4. Smtc per SSB frequency layer with values: SSB-MTC, 5. SFN0 Offset per physical cell ID: Time offset of the SFN0 slot0 of a given cell with respect to the serving Pcell, 6. SSB Index to identify one SS/PBCH block, and/or 7. SS-PBCH-BlockPower to indicate the transmit power of the SS/PBCH block.

In an example, the UE 10 can be provided with SS/PBCH blocks of a non-serving cell in resource setting through the following higher layer parameters:

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

```
        nzp-CSI-RS-ResourceSetList SEQUENCE (SIZE (1..maxNrofNZP-CSI-
RS-ResourceSetsPerConfig)) OF NZP-CSI-RS-ResourceSetId
OPTIONAL, -- Need R
        csi-SSB-ResourceSetList SEQUENCE (SIZE (1..maxNrofCSI-SSB-
ResourceSetsPerConfig)) OF CSI-SSB-ResourceSetId
OPTIONAL -- Need R
        csi-SSBNcell-ResourceSetList SEQUENCE (SIZE (1..maxNrofCSI-
SSBNcell-ResourceSetsPerConfig)) OF CSI-SSBNcell-ResourceSetId
OPTIONAL -- Need R
      },
      csi-IM-ResourceSetList SEQUENCE (SIZE (1..maxNrofCSI-IM-
ResourceSetsPerConfig)) OF CSI-IM-ResourceSetId
      },
```

| | |
|---|---|
| bwp-Id | BWP-Id, |
| resourceType | ENUMERATED { aperiodic, semiPersistent, |

```
periodic },
      ...
  }
```

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |

```
ResourcePerSet)) OF SSB-Index,
      ...
  }
```

| | |
|---|---|
| CSI-SSBNCell-ResourceSetId ::= | INTEGER (0..maxNrofCSI-SSB- |

ResourceSets−1)

| CSI-SSBNcell-ResourceSet ::= | SEQUENCE { | |
|---|---|---|
| csi-SSBNcell-ResourceSetId | CSI-SSBNcell-ResourceSetId, | |
| carrierFreq | ARFCN-ValueNR, | |
| halfFrameIndex | ENUMERATED {zero, one}, | |
| ssbSubcarrierSpacing | SubcarrierSpacing, | |
| ssb-periodicity | ENUMERATED { ms5, ms10, ms20, ms40, | |
| ms80, ms160, spare2,spare1 } | OPTIONAL | |
| smtc | SSB-MTC | OPTIONAL, |
| sfn-Offset | INTEGER (0..maxNumFFS), | |
| sfn-SSB-Offset | INTEGER (0..15), | |
| ss-PBCH-BlockPower | INTEGER (−60..50) | OPTIONAL |

| | |
|---|---|
| physicalCellId | PhysCellId, |
| ssb-IndexNcell | SSB-Index, |
| csi-SSBNcell-ResourceList | SEQUENCE (SIZE(1..maxNrofCSI- |

```
SSBNcell-ResourcePerSet)) OF SSB-Index,
      ...
  }
```

| | |
|---|---|
| CSI-SSBNcell-ResourceSetId ::= | INTEGER (0..maxNrofCSI-SSBNcell- |

ResourceSets−1)

| | |
|---|---|
| CSI-MeasConfig ::= | SEQUENCE { |

```
      nzp-CSI-RS-ResourceToAddModList SEQUENCE (SIZE (1..maxNrofNZP-
CSI-RS-Resources)) OF NZP-CSI-RS-Resource OPTIONAL, -- Need N
      nzp-CSI-RS-ResourceToReleaseList SEQUENCE (SIZE (1..maxNrofNZP-CSI-
RS-Resources)) OF NZP-CSI-RS-ResourceId OPTIONAL, -- Need N
      nzp-CSI-RS-ResourceSetToAddModList SEQUENCE (SIZE (1..maxNrofNZP-
CSI-RS-ResourceSets)) OF NZP-CSI-RS-ResourceSet
OPTIONAL, -- Need N
      nzp-CSI-RS-ResourceSetToReleaseList SEQUENCE (SIZE (1..maxNrofNZP-CSI-
RS-ResourceSets)) OF NZP-CSI-RS-ResourceSetId
OPTIONAL, -- Need N
      csi-IM-ResourceToAddModList SEQUENCE (SIZE (1..maxNrofCSI-IM-
Resources)) OF CSI-IM-Resource OPTIONAL, -- Need N
      csi-IM-ResourceToReleaseList SEQUENCE (SIZE (1..maxNrofCSI-IM-
Resources)) OF CSI-IM-ResourceId OPTIONAL, -- Need N
      csi-IM-ResourceSetToAddModList SEQUENCE (SIZE (1..maxNrofCSI-IM-
ResourceSets)) OF CSI-IM-ResourceSet OPTIONAL, -- Need N
      csi-IM-ResourceSetToReleaseList SEQUENCE (SIZE (1..maxNrofCSI-IM-
ResourceSets)) OF CSI-IM-ResourceSetId OPTIONAL, -- Need N
      csi-SSB-ResourceSetToAddModList SEQUENCE (SIZE (1..maxNrofCSI-
SSB-ResourceSets)) OF CSI-SSB-ResourceSet OPTIONAL, -- Need N
      csi-SSB-ResourceSetToReleaseList SEQUENCE (SIZE (1..maxNrofCSI-SSB-
ResourceSets)) OF CSI-SSB-ResourceSetId OPTIONAL, -- Need N
  csi-SSBNcell-ResourceSetToAddModList SEQUENCE (SIZE (1..maxNrofCSI-
SSBNcell-ResourceSets)) OF CSI-SSB-ResourceSet OPTIONAL, -- Need N
      csi-SSBNcell-ResourceSetToReleaseList SEQUENCE (SIZE (1..maxNrofCSI-
SSBNcell-ResourceSets)) OF CSI-SSB-ResourceSetId OPTIONAL, -- Need N
  csi-ResourceConfigToAddModList SEQUENCE (SIZE (1..maxNrofCSI-
ResourceConfigurations)) OF CSI-ResourceConfig
OPTIONAL, -- Need N
      csi-ResourceConfigToReleaseList SEQUENCE (SIZE (1..maxNrofCSI-
ResourceConfigurations)) OF CSI-ResourceConfigId
OPTIONAL, -- Need N
      csi-ReportConfigToAddModList SEQUENCE (SIZE (1..maxNrofCSI-
ReportConfigurations)) OF CSI-ReportConfig OPTIONAL, -- Need N
      csi-ReportConfigToReleaseList SEQUENCE (SIZE (1..maxNrofCSI-
ReportConfigurations)) OF CSI-ReportConfigId
OPTIONAL, -- Need N
```

| | |
|---|---|
| reportTriggerSize | INTEGER (0..6) |

OPTIONAL, -- Need M

| | |
|---|---|
| aperiodicTriggerStateList | SetupRelease { CSI- |
| AperiodicTriggerStateList } | OPTIONAL, -- Need M |

```
      semiPersistentOnPUSCH-TriggerStateList SetupRelease { CSI-
SemiPersistentOnPUSCH-TriggerStateList } OPTIONAL, -- Need M
      ...
}
```

In an example, SS/PBCH blocks of a non-serving cell can be configured in aperiodic CSI reporting through the following higher parameter:

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

```
(SIZE(1..maxNrofReportConfigPerAperiodicTrigger)) OF CSI-AssociatedReportConfigInfo,
      ...
  }
```

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP- |

CSI-RS-ResourceSetsPerConfig),

| | |
|---|---|
| qcl-info | SEQUENCE |

(SIZE(1..maxNrofAP-CSI-RS-ResourcesPerSet)) OF TCI-StateId
OPTIONAL -- Cond Aperiodic
},

| | |
|---|---|
| csi-SSB-ResourceSet | INTEGER (1..maxNrofCSI-SSB- |

ResourceSetsPerConfig)

| | |
|---|---|
| csi-SSBNcell-ResourceSet | INTEGER (1..maxNrofCSI- |

SSBNcell-ResourceSetsPerConfig)
},

| | |
|---|---|
| csi-IM-ResourcesForInterference | INTEGER(1..maxNrofCSI-IM- |

ResourceSetsPerConfig)
OPTIONAL, -- Cond CSI-IM-ForInterference

| | |
|---|---|
| nzp-CSI-RS-ResourcesForInterference | INTEGER (1..maxNrofNZP-CSI-RS- |

ResourceSetsPerConfig)
OPTIONAL, -- Cond NZP-CSI-RS-ForInterference
...
}

Beam Indication for DL Channel/Signal:

In an exemplary method, the UE 10 can be configured with a list of up to M TCI-State configurations within a higher layer parameter PDSCH-Config to decode PDSCH according to a detected PDCCH with DCI intended for the UE 10 and the given serving cell 20, where M depends on the UE capability maxNumberConfiguredTCIstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types are not the same, regardless of whether the references are to the same DL RS or different DL RSs. The quasi co-location types corresponding to each DL RS are given by the higher layer parameter qcl-Type in QCL-Info and may take one of the following values: ‘QCL-Type A’: {Doppler shift, Doppler spread, average delay, delay spread}, ‘QCL-Type B’: {Doppler shift, Doppler spread}, ‘QCL-Type C’: {Doppler shift, average delay}, and/or ‘QCL-Type D’: {Spatial Rx parameter}.

The DL RS can be one SS/PBCH block on one non-serving cell. To configure one SS/PBCH block of one non-serving cell in a TCI-state, the UE 10 can be provided one or more of the following parameters: Physical cell Id (PCI) of the cell to identify one cell, ssbFrequency with values: ARFCN-ValueNR to indicate the carrier frequency of the SS/PBCH transmission, halfFrameIndex with values: 0 or 1, SSB periodicity to indicate the transmission periodicity of the SS/PBCH blocks, ssbSubcarrierSpacing to indicate the subcarrier spacing used by the SS/PBCH block transmission, SFN-SSBoffset to indicate the slot offset of the SS/PBCH block transmission, Smtc per SSB frequency layer with values: SSB-MTC, SFN0 Offset per physical cell ID: Time offset of the SFN0 slot0 of a given cell with respect to the serving Pcell, SSB Index to identify one SS/PBCH block, and/or SS-PBCH-BlockPower to indicate the transmit power of the SS/PBCH block.

In one example, a TCI-state can be configured through the following higher layer parameters:

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
      ...
  }
```

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |
| ssbNcell | SSB-InfoNcell, |

},

| | |
|---|---|
| qcl-Type | ENUMERATED {typeA, typeB, typeC, |

```
typeD},
      ...
  }
```

| SSB-Configuration ::= | SEQUENCE { | |
|---|---|---|
| carrierFreq | ARFCN-ValueNR, | |
| halfFrameIndex | ENUMERATED {zero, one}, | |
| ssbSubcarrierSpacing | SubcarrierSpacing, | |
| ssb-periodicity | ENUMERATED { ms5, ms10, ms20, ms40, | |
| ms80, ms160, spare2,spare1 } | OPTIONAL, -- Need S | |
| smtc | SSB-MTC | OPTIONAL, - |

- Need S

| sfn-Offset | INTEGER (0..maxNumFFS), | |
|---|---|---|
| sfn-SSB-Offset | INTEGER (0..15), | |
| ss-PBCH-BlockPower | INTEGER (−60..50) | OPTIONAL |

```
  }
  SSB-InfoNcell ::= SEQUENCE {
```

| | |
|---|---|
| physicalCellId | PhysCellId, |
| ssb-IndexNcell | SSB-Index, |
| ssb-Configuration | SSB-Configuration |

OPTIONAL -- Need M
}

In an example, for a periodic CSI-RS resource in an NZP-CSI-RS-ResourceSet configured with higher layer parameter trs-Info, the UE 10 can expect that a TCI-State indicates one of the following quasi co-location type(s): 1. ‘QCL-Type C’ with an SS/PBCH block or an SS/PBCH block of a non-serving cell and, when applicable, ‘QCL-Type D’ with the same SS/PBCH block, and/or 2. ‘QCL-Type C’ with an SS/PBCH block or an SS/PBCH block of a non-serving cell and, when applicable, ‘QCL-Type D’ with a CSI-RS resource in an NZP-CSI-RS-ResourceSet configured with higher layer parameter repetition.

In another example, for a CSI-RS resource in an NZP-CSI-RS-ResourceSet configured without higher layer parameter trs-Info and without the higher layer parameter repetition, the UE 10 can expect that a TCI-State indicates one of the following quasi co-location type(s): 1. ‘QCL-Type A’ with a CSI-RS resource in a NZP-CSI-RS-ResourceSet configured with higher layer parameter trs-Info and, when applicable, ‘QCL-Type D’ with the same CSI-RS resource, 2. ‘QCL-Type A’ with a CSI-RS resource in a NZP-CSI-RS-ResourceSet configured with higher layer parameter trs-Info and, when applicable, ‘QCL-Type D’ with an SS/PBCH block or an SS/PBCH block of a non-serving cell, 3. ‘QCL-Type A’ with a CSI-RS resource in a NZP-CSI-RS-ResourceSet configured with higher layer parameter trs-Info and, when applicable, ‘QCL-Type D’ with a CSI-RS resource in a NZP-CSI-RS-ResourceSet configured with higher layer parameter repetition, and/or 4. ‘QCL-Type B’ with a CSI-RS resource in a NZP-CSI-RS-ResourceSet configured with higher layer parameter trs-Info when ‘QCL-Type D’ is not applicable.

For a CSI-RS resource in an NZP-CSI-RS-ResourceSet configured with higher layer parameter repetition, the UE 10 can expect that a TCI-State indicates one of the following quasi co-location type(s): 1. ‘QCL-Type A’ with a CSI-RS resource in a NZP-CSI-RS-ResourceSet configured with higher layer parameter trs-Info and, when applicable, ‘QCL-Type D’ with the same CSI-RS resource, 2. ‘QCL-Type A’ with a CSI-RS resource in a NZP-CSI-RS-ResourceSet configured with higher layer parameter trs-Info and, when applicable, ‘QCL-Type D’ with a CSI-RS resource in a NZP-CSI-RS-ResourceSet configured with higher layer parameter repetition, and/or 3. ‘QCL-Type C’ with an SS/PBCH block or an SS/PBCH block of a non-serving cell and, when applicable, ‘QCL-Type D’ with the same SS/PBCH block.

Beam Indication for PUCCH:

In an exemplary method, for PUCCH transmission, the UE 10 can be provided with an SS/PBCH block of a non-serving cell in PUCCH spatial relation information configured to one PUCCH resources. With that, the UE 10 can determine a spatial setting for the PUCCH transmission according to the configured SS/PBCH block of a non-serving cell. For the PUCCH resource, the UE 10 can also be provided with a SS/PBCH block of a non-serving cell as the pathloss RS for the PUCCH transmission. To configure one SS/PBCH block of one non-serving cell as spatial relation information for PUCCH or pathloss reference signal for PUCCH transmission, the UE 10 can be provided one or more of the following parameters: 1. Physical cell Id (PCI) of the cell to identify one cell, 2. ssbFrequency with values: ARFCN-ValueNR to indicate the carrier frequency of the SS/PBCH transmission, 3. halfFrameIndex with values: 0 or 1, 4. SSB-periodicity to indicate the transmission periodicity of the SS/PBCH blocks, 5. ssbSubcarrierSpacing to indicate the subcarrier spacing used by the SS/PBCH block transmission, 6. SFN-SSBoffset to indicate the slot offset of the SS/PBCH block transmission, 7. Smtc per SSB frequency layer with values: SSB-MTC, SFN0 Offset per physical cell ID: Time offset of the SFN0 slot0 of a given cell with respect to the serving Pcell, 8. SSB Index to identify one SS/PBCH block, and/or 9. SS-PBCH-BlockPower to indicate the transmit power of the SS/PBCH block.

In an exemplary example, the spatial relation information for PUCCH can be provided through the higher layer parameter as follows:

| | |
|---|---|
| PUCCH-SpatialRelationInfo ::= | SEQUENCE { |
| pucch-SpatialRelationInfoId | PUCCH-SpatialRelationInfoId, |
| servingCellId | ServCellIndex |

OPTIONAL, -- Need S

| | |
|---|---|
| referenceSignal | CHOICE { |
| ssb-Index | SSB-Index, |
| csi-RS-Index | NZP-CSI-RS-ResourceId, |
| srs | SEQUENCE { |
| | resource |

SRS-ResourceId,

uplinkBWP

BWP-Id

| | |
|---|---|
| | } |
| ssbNcell | SSB-InfoNcell, |

},

| | |
|---|---|
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |

}

| | |
|---|---|
| PUCCH-PathlossReferenceRS-Id ::= | INTEGER (0..maxNrofPUCCH- |

PathlossReferenceRSs−1)

| | |
|---|---|
| PUCCH-PathlossReferenceRS ::= | SEQUENCE { |
| pucch-PathlossReferenceRS-Id | PUCCH-PathlossReferenceRS-Id, |
| referenceSignal | CHOICE { |
| ssb-Index | SSB-Index, |
| csi-RS-Index | NZP-CSI-RS-ResourceId |
| ssbNcell | SSB-InfoNcell, |

```
      }
  }
```

| SSB-Configuration ::= | SEQUENCE { | |
|---|---|---|
| carrierFreq | ARFCN-ValueNR, | |
| halfFrameIndex | ENUMERATED {zero, one}, | |
| ssbSubcarrierSpacing | SubcarrierSpacing, | |
| ssb-periodicity | ENUMERATED { ms5, ms10, ms20, ms40, | |
| ms80, ms160, spare2,spare1 } | OPTIONAL, -- Need S | |
| smtc | SSB-MTC | OPTIONAL, - |

- Need S

| sfn-Offset | INTEGER (0..maxNumFFS), | |
|---|---|---|
| sfn-SSB-Offset | INTEGER (0..15), | |
| ss-PBCH-BlockPower | INTEGER (−60..50) | OPTIONAL |

```
  }
  SSB-InfoNcell ::= SEQUENCE {
```

| | |
|---|---|
| physicalCellId | PhysCellId, |
| ssb-IndexNcell | SSB-Index, |
| ssb-Configuration | SSB-Configuration |

OPTIONAL -- Need M
}

In some embodiments, a spatial setting for a PUCCH transmission is provided by PUCCH-SpatialRelationInfo if the UE 10 is configured with a single value for pucch-SpatialRelationInfold; otherwise, if the UE 10 is provided multiple values for PUCCH-SpatialRelationInfo, the UE 10 determines a spatial setting for the PUCCH transmission as described in TS 38.321. The UE 10 applies corresponding actions in TS 38.321 and a corresponding setting for a spatial domain filter to transmit PUCCH in the first slot that is after slot k+3·Nₛₗₒₜ^{subframe,μ} where k is the slot where the UE 10 would transmit a PUCCH with HARQ-ACK information with ACK value corresponding to a PDSCH reception providing the PUCCH-SpatialRelationInfo and μ is the SCS configuration for the PUCCH.

In some embodiments, if PUCCH-SpatialRelationInfo provides ssb-Index, the UE 10 transmits the PUCCH using a same spatial domain filter as for a reception of a SS/PBCH block with index provided by ssb-Index for a same serving cell or, if servingCellId is provided, for a serving cell indicated by servingCellId. Else if PUCCH-SpatialRelationInfo provides csi-RS-Index, the UE 10 transmits the PUCCH using a same spatial domain filter as for a reception of a CSI-RS with resource index provided by csi-RS-Index for a same serving cell or, if servingCellId is provided, for a serving cell indicated by servingCellId. Else if PUCCH-SpatialRelationInfo provides srs, the UE 10 transmits the PUCCH using a same spatial domain filter as for a transmission of a SRS with resource index provided by resource for a same serving cell and/or active UL BWP or, if servingCellId and/or uplinkBWP are provided, for a serving cell indicated by servingCellId and/or for an UL BWP indicated by uplinkBWP. Else PUCCH-SpatialRelationInfo provides ssbNcell, the UE 10 transmits the PUCCH using a same spatial domain filter as for a reception of a SS/PBCH block of a non-serving cell provided by ssbNcell.

For PUSCH:

In an exemplary method, the UE 10 can be configured with a SS/PBCH block as the pathloss reference signal for PUSCH transmission. To configure one SS/PBCH block of one non-serving cell as the pathloss reference signal for PUSCH transmission, the UE 10 can be provided one or more of the following parameters: 1. Physical cell Id (PCI) of the cell to identify one cell, 2. ssbFrequency with values: ARFCN-ValueNR to indicate the carrier frequency of the SS/PBCH transmission, 3. halfFrameIndex with values: 0 or 1, 4. SSB periodicity to indicate the transmission periodicity of the SS/PBCH blocks, 5. ssbSubcarrierSpacing to indicate the subcarrier spacing used by the SS/PBCH block transmission, 6. SFN-SSBoffset to indicate the slot offset of the SS/PBCH block transmission, 7. Smtc per SSB frequency layer with values: SSB-MTC, 8. SFN0 Offset per physical cell ID: Time offset of the SFN0 slot0 of a given cell with respect to the serving Pcell, 9. SSB Index to identify one SS/PBCH block, and/or 10. SS-PBCH-BlockPower to indicate the transmit power of the SS/PBCH block.

In one example, one SS/PBCH block of a non-serving cell can be provided as pathloss reference signal for PUSCH transmission through the following higher layer parameters:

| | |
|---|---|
| PUSCH-PowerControl ::= | SEQUENCE { |
| tpc-Accumulation | ENUMERATED { disabled } |

OPTIONAL, -- Need S

| | |
|---|---|
| msg3-Alpha | Alpha |

OPTIONAL, -- Need S

| | |
|---|---|
| p0-NominalWithoutGrant | INTEGER (−202..24) |

OPTIONAL, -- Need M

| | |
|---|---|
| p0-AlphaSets | SEQUENCE (SIZE (1..maxNrofP0- |
| PUSCH-AlphaSets)) OF P0-PUSCH-AlphaSet | OPTIONAL, -- Need M |
| pathlossReferenceRSToAddModList | SEQUENCE (SIZE (1..maxNrofPUSCH- |

PathlossReferenceRSs)) OF PUSCH-PathlossReferenceRS
OPTIONAL, -- Need N

| | |
|---|---|
| pathlossReferenceRSToReleaseList | SEQUENCE (SIZE (1..maxNrofPUSCH- |

PathlossReferenceRSs)) OF PUSCH-PathlossReferenceRS-Id
OPTIONAL, -- Need N

| | |
|---|---|
| twoPUSCH-PC-AdjustmentStates | ENUMERATED {twoStates} |

OPTIONAL, -- Need S

| | |
|---|---|
| deltaMCS | ENUMERATED {enabled} |

OPTIONAL, -- Need S

| | |
|---|---|
| sri-PUSCH-MappingToAddModList | SEQUENCE (SIZE (1..maxNrofSRI- |

PUSCH-Mappings)) OF SRI-PUSCH-PowerControl
OPTIONAL, -- Need N

| | |
|---|---|
| sri-PUSCH-MappingToReleaseList | SEQUENCE (SIZE (1..maxNrofSRI- |

PUSCH-Mappings)) OF SRI-PUSCH-PowerControlId
OPTIONAL -- Need N
}

| | |
|---|---|
| P0-PUSCH-AlphaSet ::= | SEQUENCE { |
| p0-PUSCH-AlphaSetId | P0-PUSCH-AlphaSetId, |
| p0 | INTEGER (−16..15) |

OPTIONAL, -- Need S

| | |
|---|---|
| alpha | Alpha |

OPTIONAL -- Need S
}

| | |
|---|---|
| P0-PUSCH-AlphaSetId ::= | INTEGER (0..maxNrofP0-PUSCH-AlphaSets- |

1)

| | |
|---|---|
| PUSCH-PathlossReferenceRS ::= | SEQUENCE { |
| pusch-PathlossReferenceRS-Id | PUSCH-PathlossReferenceRS-Id, |
| referenceSignal | CHOICE { |
| ssb-Index | SSB-Index, |
| csi-RS-Index | NZP-CSI-RS-ResourceId |
| ssbNcell | SSB-InfoNcell |

```
      }
  }
```

| SSB-Configuration::= | SEQUENCE { | |
|---|---|---|
| carrierFreq | ARFCN-ValueNR, | |
| halfFrameIndex | ENUMERATED {zero, one}, | |
| ssbSubcarrierSpacing | SubcarrierSpacing, | |
| ssb-periodicity | ENUMERATED { ms5, ms10, ms20, ms40, | |
| ms80, ms160, spare2,spare1 } | OPTIONAL, -- Need S | |
| smtc | SSB-MTC | OPTIONAL, - |

- Need S

| sfn-Offset | INTEGER (0..maxNumFFS), | |
|---|---|---|
| sfn-SSB-Offset | INTEGER (0..15), | |
| ss-PBCH-BlockPower | INTEGER (−60..50) | OPTIONAL |

```
  }
  SSB-InfoNcell ::= SEQUENCE {
```

| | |
|---|---|
| physicalCellId | PhysCellId, |
| ssb-IndexNcell | SSB-Index, |
| ssb-Configuration | SSB-Configuration |

```
  OPTIONAL -- Need M
  }
```

| | |
|---|---|
| PUSCH-PathlossReferenceRS-Id ::= | INTEGER (0..maxNrofPUSCH- |

PathlossReferenceRSs−1)

| | |
|---|---|
| SRI-PUSCH-PowerControl ::= | SEQUENCE { |
| sri-PUSCH-PowerControlId | SRI-PUSCH-PowerControlId, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoopIndex | ENUMERATED { i0, i1 } |

}

| | |
|---|---|
| SRI-PUSCH-PowerControlId ::= | INTEGER (0..maxNrofSRI-PUSCH-Mappings−1) |

In summary, some embodiments of the present disclosure provide the following methods for beam management of a non-serving cell. A serving cell configures a UE 10 to measure a set of SS/PBCH blocks of a non-serving cell. The UE 10 reports a L1-RSRP measurement and SSBRI of SS/PBCH blocks of the non-serving cell. A gNB 20 configures one SS/PBCH block of a non-serving cell for QCL type in a TCI-state. The gNB 20 configures one SS/PBCH block of a non-serving cell in a spatial relation information for a PUCCH resource. The gNB 20 configures one SS/PBCH block of a non-serving cell as a pathloss reference signal for a PUCCH transmission. The gNB 20 configures one SS/PBCH block of a non-serving cell as a pathloss reference signal for PUSCH transmission.

The following 3rd Generation Partnership Project (3GPP) standards are incorporated in some embodiments of the present disclosure by reference in their entireties: 3GPP TS 38.211 V16.0.0: “NR; Physical channels and modulation”, 3GPP TS 38.212 V16.0.0: “NR; Multiplexing and channel coding”, 3GPP TS 38.213 V16.0.0: “NR; Physical layer procedures for control”, 3GPP TS 38.214 V16.0.0: “NR; Physical layer procedures for data”, 3GPP TS 38.215 V16.0.0: “NR; Physical layer measurements”, 3GPP TS 38.321 V16.0.0: “NR; Medium Access Control (MAC) protocol specification”, and/or 3GPP TS 38.331 V16.0.0: “NR; Radio Resource Control (RRC) protocol specification”.

The following table includes some abbreviations used in some embodiments of the present disclosure:

| | |
|---|---|
| 3GPP | 3rd Generation Partnership Project |
| 5G | 5th Generation |
| NR | New Radio |
| gNB | Next generation NodeB |
| DL | Downlink |
| UL | Uplink |
| PUSCH | Physical Uplink Shared Channel |
| PUCCH | Physical Uplink Control Channel |
| PDSCH | Physical Downlink Shared Channel |
| PDCCH | Physical Downlink Control Channel |
| SRS | Sounding Reference Signal |
| CSI | Channel state information |
| CSI-RS | Channel state information reference signal |
| CSI-IM | Channel state information-interference measurement |
| NZP CSI-RS | Non-zero-power Channel state information reference signal |
| RS | Reference Signal |
| CORESET | Control Resource Set |
| DCI | Downlink control information |
| TRP | Transmission/reception point |
| ACK | Acknowledge |
| NACK | Non-Acknowledge |
| UCI | Uplink control information |
| RRC | Radio Resource Control |
| HARQ | Hybrid Automatic Repeat Request |
| MAC | Media Access Control |
| CRC | Cyclic Redundancy Check |
| RNTI | Radio Network Temporary Identity |
| RB | Resource Block |
| PRB | Physical Resource Block |
| NW | Network |
| RSRP | Reference signal received power |
| L1-RSRP | Layer 1 Reference signal received power |
| TCI | Transmission Configuration Indicator |
| Tx | Transmission |
| Rx | Receive |
| QCL | Quasi co-location |
| SSB | SS/PBCH Block |
| PBCH | Physical broadcast channel |
| SSS | Secondary synchronization signal |
| CRI | CSI-RS resource indicator |
| SSBRI | SS/PBCH block resource indicator |
| SINR | Signal to Interference Noise Ratio |
| L1-SINR | Layer 1 Signal to Interference Noise Ratio |
| DMRS | Demodulation Reference Signal |

Commercial interests for some embodiments are as follows. 1. Solving issues in the prior art. 2. Providing a beam management of a non-serving cell. 3. Improving a latency in a multi-beam operation. 4. Providing a good communication performance 5 Providing high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. The deployment scenarios include, but not limited to, indoor hotspot, dense urban, urban micro, urban macro, rural, factor hall, and indoor D2D scenarios. Some embodiments of the present disclosure are a combination of “techniques/processes” that can be adopted in 3GPP specification to create an end product. Some embodiments of the present disclosure could be adopted in 5G NR licensed and non-licensed or shared spectrum communications. Some embodiments of the present disclosure propose technical mechanisms. The present example embodiment is applicable to NR in unlicensed spectrum (NR-U). The present disclosure can be applied to other mobile networks, in particular to mobile network of any further generation cellular network technology (6G, etc.).

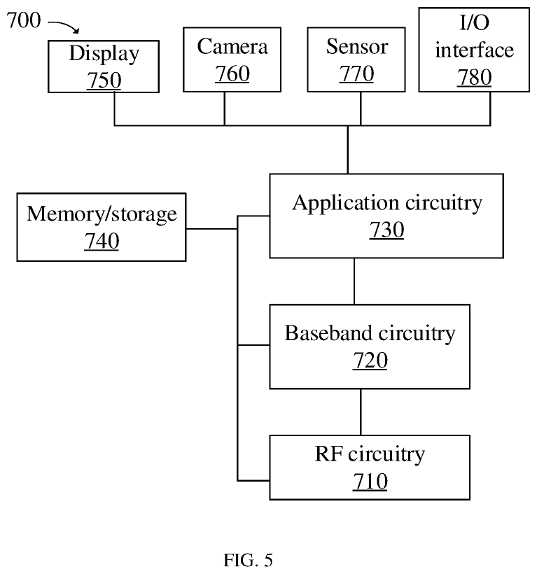

FIG. 5 is a block diagram of an example system 700 for wireless communication according to an embodiment of the present disclosure. Embodiments described herein may be implemented into the system using any suitably configured hardware and/or software. FIG. 5 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method by a first base station, comprising:
configuring, by the first base station configured to control a serving cell to a user equipment (UE), the UE to measure transmission beams transmitted by a second base station configured to control a non-serving cell to the UE.

2. The method of claim 1, further comprising requesting the UE to report a measurement of the transmission beams transmitted by the second base station.

3. The method of claim 2, wherein the measurement of the transmission beams transmitted by the second base station comprises a reference signal received power (RSRP) measurement, a reference symbol received quality (RSRQ) measurement, or a signal to interference noise ratio (SINR) measurement of the transmission beams transmitted by the second base station.

4. The method of claim 3, wherein the RSRP measurement, the RSRQ measurement, or the SINR measurement of the transmission beams transmitted by the second base station comprises a layer 1 RSRP (L1-RSRP) measurement, a layer 1 RSRQ (L1-RSRQ) measurement, or a layer 1 SINR (L1-SINR) measurement of the transmission beams transmitted by the second base station.

5. The method of claim 1, further comprising configuring the UE to receive a downlink channel or signal with a beam of the transmission beams transmitted by the second base station.

6. The method of claim 5, wherein the downlink channel or signal comprises a physical downlink shared channel (PDSCH), a physical downlink control channel (PDCCH), or a CSI-RS resource.

7. The method of claim 5, wherein the beam of the transmission beams transmitted by the second base station is configured by the first base station for a quasi co-location (QCL) type in a transmission configuration indicator (TCI) state.

8. A user equipment (UE), comprising:
a memory;
a transceiver; and
a processor coupled to the memory and the transceiver;
wherein the processor is configured, by a first base station configured to control a serving cell to the UE, to measure transmission beams transmitted by a second base station configured to control a non-serving cell to the UE.

9. The UE of claim 8, wherein the transmission beams are transmitted through channel state information reference signal (CSI-RS) resources or synchronization signal (SS)/physical broadcast channel (PBCH) blocks transmitted by the second base station.

10. The UE of claim 8, wherein the processor is requested, by the first base station, to report a measurement of the transmission beams transmitted by the second base station.

11. The UE of claim 10, wherein the measurement of the transmission beams transmitted by the second base station comprises a reference signal received power (RSRP) measurement, a reference symbol received quality (RSRQ) measurement, or a signal to interference noise ratio (SINR) measurement of the transmission beams transmitted by the second base station.

12. The UE of claim 11, wherein the RSRP measurement, the RSRQ measurement, or the SINR measurement of the transmission beams transmitted by the second base station comprises a layer 1 RSRP (L1-RSRP) measurement, a layer 1 RSRQ (L1-RSRQ) measurement, or a layer 1 SINR (L1-SINR) measurement of the transmission beams transmitted by the second base station.

13. A first base station, comprising:
a memory;
a transceiver; and
a processor coupled to the memory and the transceiver and configured to control a serving cell to a user equipment (UE);
wherein the processor is configured to configure the UE to measure transmission beams transmitted by a second base station configured to control a non-serving cell to the UE.

14. The first base station of claim 13, wherein the processor is configured to request the UE to report a measurement of the transmission beams transmitted by the second base station.

15. The first base station of claim 14, wherein the measurement of the transmission beams transmitted by the second base station comprises a reference signal received power (RSRP) measurement, a reference symbol received quality (RSRQ) measurement, or a signal to interference noise ratio (SINR) measurement of the transmission beams transmitted by the second base station.

16. The first base station of claim 15, wherein the RSRP measurement, the RSRQ measurement, or the SINR measurement of the transmission beams transmitted by the second base station comprises a layer 1 RSRP (L1-RSRP) measurement, a layer 1 RSRQ (L1-RSRQ) measurement, or a layer 1 SINR (L1-SINR) measurement of the transmission beams transmitted by the second base station.

17. The first base station of claim 13, wherein the processor is configured to configure the UE to transmit an uplink channel or signal with an uplink transmission beam, wherein the uplink transmission beam is aligned with a beam of the transmission beams transmitted by the second base station.

18. The first base station of claim 17, wherein the uplink channel or signal comprises a physical uplink shared channel (PUSCH) or a physical uplink control channel (PUCCH).

19. The first base station of claim 18, wherein the beam of the transmission beams transmitted by the second base station is configured by the first base station in a spatial relation information for a PUCCH resource.

20. The first base station of claim 18, wherein the beam of the transmission beams transmitted by the second base station is configured by the first base station as a pathloss reference signal for a PUCCH transmission or a PUSCH transmission.
